(19) United States
(12) Patent Application Publication
(10) Pub. No.: US 2023/0376036 A1
(43) Pub. Date: Nov. 23, 2023

(54) Platform and Mission Agnostic Autonomy Framework

(71) Applicant: Booz Allen Hamilton Inc., McLean, VA (US)

(72) Inventors: Christopher Hurite MACDONALD, Alexandria, VA (US); Daniel IRIZARRY, Arlington, VA (US); Ibrahim Karim AKBAR, Arlington, VA (US); Eric Omar NIEVES, Arlington, VA (US); Paul Christopher D’ANGIO, Great Falls, VA (US); Chantal Chabela MURDOCK, Arlington, VA (US)

(73) Assignee: Booz Allen Hamilton Inc., McLean, VA (US)

(21) Appl. No.: 18/319,574

(22) Filed: May 18, 2023

Related U.S. Application Data
(60) Provisional application No. 63/343,746, filed on May 19, 2022.

(51) Int. Cl. G05D 1/00; G05B 19/4155

(52) U.S. Cl. CPC G05D 1/0088; G05B 19/4155; G05B 2219/50391

(57) ABSTRACT

Embodiments relate to an autonomous action deployment system having one or more processors. The system includes a mission behavior manager (MBM) module and an autonomous action controller (AAC) module. A processor is configured to interface with one or more autonomous vehicle platforms. The MBM module is configured to receive a mission script that includes a text file, parse the text file into actions, create a data structure where each action exists as a node in a connected graph, validate that each node corresponds with a plug-in stored in a plug-in library specific to an autonomous vehicle platform, and generate an action request command. The AAC module is configured to receive the action request command and execute steps to accomplish the action request command for the autonomous vehicle platform via a corresponding driver.

### CROSS-REFERENCE TO RELATED APPLICATIONS

This patent application is related to and claims the benefit of priority of U.S. provisional patent application No. 63/343,746, filed on May 19, 2022, the entire contents of which is incorporated herein by reference.

### FIELD

Embodiments relate to a framework having two main components (e.g., operating modules) that work in tandem: a Mission Behavior Manager (MBM) module configured to translate mission scripts into actionable pieces of information; and an Autonomous Action Controller (AAC) module configured to interface with the MBM module to carry out commands with vendor-specific peripherals, sensors, and payloads.

### BACKGROUND INFORMATION

With known technology in the field of robotics and autonomy, autonomy is very platform specific if it exists at all. There is a need to provide an autonomy framework that can facilitate the deploying and managing of autonomy at scale via reusability of autonomy algorithms, collaboration among network participants, and an increase in human-machine teaming. More specifically, there is a need to provide a framework that can operate with a set of predefined commands to allow a user to customize their mission with various unmanned platforms and payloads—i.e., allow a user to use predefined commands to build tailored missions in a manner that is agnostic to the desired mission and to the autonomy framework upon which the mission is to be carried out.

### SUMMARY

Embodiments relate to an autonomous action deployment system having one or more processors. The system includes a mission behavior manager (MBM) module and an autonomous action controller (AAC) module. A processor is configured to interface with one or more autonomous vehicle platforms. The MBM module is configured to receive a mission script that includes a text file, parse the text file into actions, create a data structure where each action exists as a node in a connected graph, validate that each node corresponds with a plug-in stored in a plug-in library specific to an autonomous vehicle platform, and generate an action request command. The AAC module is configured to receive the action request command and execute steps to accomplish the action request command for the autonomous vehicle platform via a corresponding driver.

Embodiments relate to a method of deploying an autonomous action. The method involves receiving a mission script that includes a text file. The method involves parsing the text file into actions. The method involves creating a data structure where each action exists as a node in a connected graph. The method involves validating that each node corresponds with a plug-in stored in a plug-in library specific to an autonomous vehicle platform. The method involves generating an action request command. The method involves executing steps to accomplish the action request command for the autonomous vehicle platform via a corresponding driver.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system flow diagram that can be used to implement embodiment of the method disclosed herein;

FIG. 2 shows an exemplary system architecture;

FIG. 3 shows an exemplary Mission Behavior Manager module configuration;

FIG. 4 shows an exemplary Autonomous Action Controller module configuration; and

FIG. 5 shows an exemplary Interface Agent module.

### DETAILED DESCRIPTION

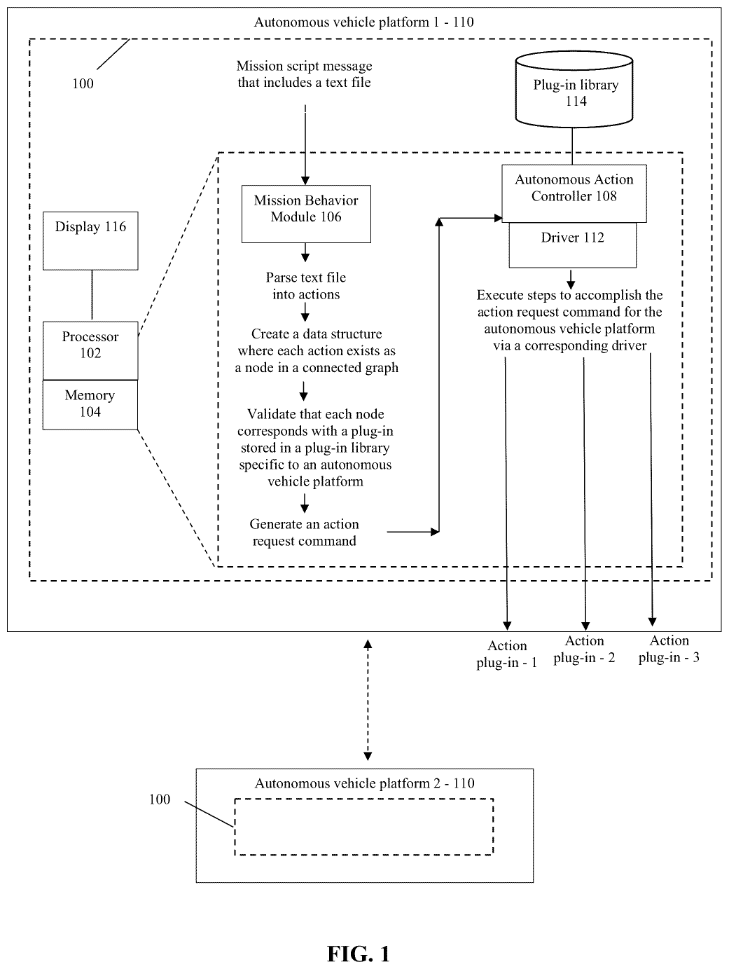

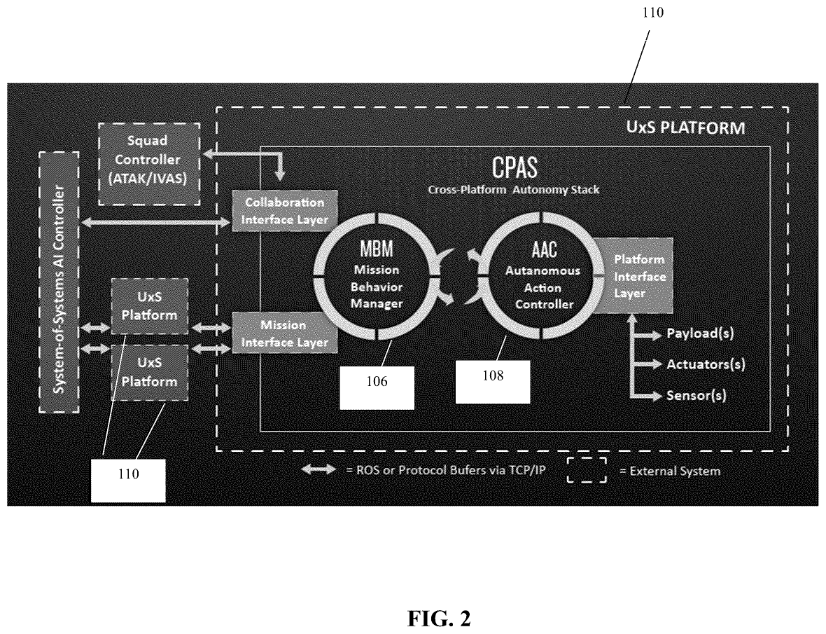

Referring to FIGS. 1-2, embodiments relate to an autonomous action deployment system 100. The system 100 can include a processor 102 or a processing module. This disclosure may reference one or more processors 102 on one or more processing modules. Any of the processing modules discussed herein can include a processor 102 and associated memory 104. A processing module can be embodied as software and stored in memory 104, the memory 104 being operatively associated with the processor 102. A processing module can be a software or firmware operating module configured to implement any of the method steps or algorithms disclosed herein. A processing module can be embodied as a web application, a desktop application, a console application, etc. Any of the processors 102 discussed herein can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. It should be noted that use of processors 102 herein can include Graphics Processing Units (GPUs), Field Programmable Gate Arrays (FPGAs), Central Processing Units (CPUs), etc. Any of the memory 104 discussed herein can be computer readable memory configured to store data. The memory 104 can include a volatile or non-volatile, transitory or non-transitory memory (e.g., as a Random Access Memory (RAM)), and be embodied as an in-memory, an active memory, a cloud memory, etc. Embodiments of the memory 104 can include a processor module and other circuitry to allow for the transfer of data to and from the memory 104, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The autonomous action deployment system 100 can include one or more processors 102. The one or more processors 102 can include a mission behavior manager (MBM) module 106 and an autonomous action controller (AAC) module 108. The MBM module 106 and the AAC module 108 are configured to allow or facilitate the one or more processors 102 to interface with one or more autonomous vehicle platforms 110. As will be explained in more detail, the system 100 includes a framework (may be referred to herein as Cross Platform Autonomy Stack (CPAS)) to translate mission scripts into actionable pieces of information that can be applicable to any autonomous vehicle platform 110, or to multiple autonomous vehicle platforms 110. The framework includes the MBM module 106 for the translation and the AAC module 108 for interfacing with the MBM module 106, executing plug-ins, and carry out commands with vendor-specific peripherals, sensors, and payloads of the autonomous vehicle platform(s) 110.

The MBM module 106 is configured to receive a mission script that includes a text file. The mission script(s) and text file(s) can be stored in memory 104 for later processing. This can include storing the mission script(s) and text file(s) in tables or other forms of storage representation. The MBM module 106 is configured to parse the text file into actions. The MBM module 106 is configured to create a data structure where each action exists as a node in a connected graph. The connected graph data structure can be stored in memory 104. The MBM module 106 can then validate that each node corresponds with a plug-in stored in a plug-in library 114. This can be achieved via standard validation methods. The plug-in library 114 and other libraries disclosed herein can be in the form of memory, such as a database for example. The corresponding plug-in can be specific to an autonomous vehicle platform 110. For instance, the MBM module 106 can validate that a node corresponds to a plug-in in the plug-in library 114, wherein that plug-in is specific to one of an autonomous vehicle platform 110 upon which the mission script will be used. For example, the system 100 can be used to receive a mission script and use that mission script to carry out commands with vendor-specific peripherals, sensors, and payloads associated with one or more autonomous vehicle platform(s) 110. There can be more than one autonomous vehicle platforms 110. In some embodiments, the plural autonomous vehicle platforms 110 can be a network of autonomous vehicle platforms 110. Thus, the MBM module 106 validates that each node corresponds to a plug-in for one or more of the autonomous vehicle platform(s) 110. After validation, the MBM module 106 can generate an action request command.

The action request command is transmitted to the AAC module 108. This is done via the MBM module 106 sending the action request command (a push operation).

The AAC module 108 is configured to receive the action request command and execute steps to accomplish the action request command for the autonomous vehicle platform 110. This can be achieved via a corresponding driver 112 (e.g., a software interface to hardware device(s) of the platform 110), for example.

It is understood that the framework (e.g., the CPAS)) of the system 100 resides on each autonomous vehicle platform 110 and connects each unique autonomous vehicle platform 110 via a standard means of data sharing. With reference to FIG. 2, there are three Generalized Unmanned System platforms (e.g., three UxS platforms): two smaller boxes on the left and the main box in the middle/right. The CPAS box is surround with a UxS platform dotted box. Each of the small boxes looks identical to the larger box, but do not show CPAS due to space constraints, yet the CPAS is there. Thus, the CPAS can exists uniquely on multiple platforms 110.

The mission script is an action or behavior command signal or aggregate for one or more autonomous vehicle platforms 110. For instance, a mission script can be a command aggregate that, when implemented, causes a vehicle (or more than one vehicle) on an autonomous vehicle platform 110 (or more than one autonomous vehicle platforms 110) to move in a desired direction, moved to a desired location, perform a task (e.g., climb stairs, hover over a location, take a sample, etc.), etc. The mission script can be one or more action or behavior command aggregates that, when acted upon, achieve one or more goals. For instance, the goal can be to move to location X, take a sample, analyze the sample, move to location Y, and transmit analysis of the sample from location Y. The mission script can include multiple action or behavior command aggregates to accomplish this goal. A single mission script can be for one or more vehicles or one or more autonomous vehicle platforms 110.

The MBM module 106 can be configured to receive plural mission scripts. For each mission script, the MBM module 106 can parse the text file into actions. The MBM module 106 can create a data structure where each action exists as a node in a connected graph. The MBM module 106 can then validate that each node corresponds with a plug-in stored in a plug-in library 114. Each corresponding plug-in can be specific to an autonomous vehicle platform 110. After validation, the MBM module 106 can generate plural action request commands. The AAC module 108 can be configured to execute one or more action plug-ins for each node of each mission script. For example, the AAC module 108 can execute one or more plug-ins for each action request command.

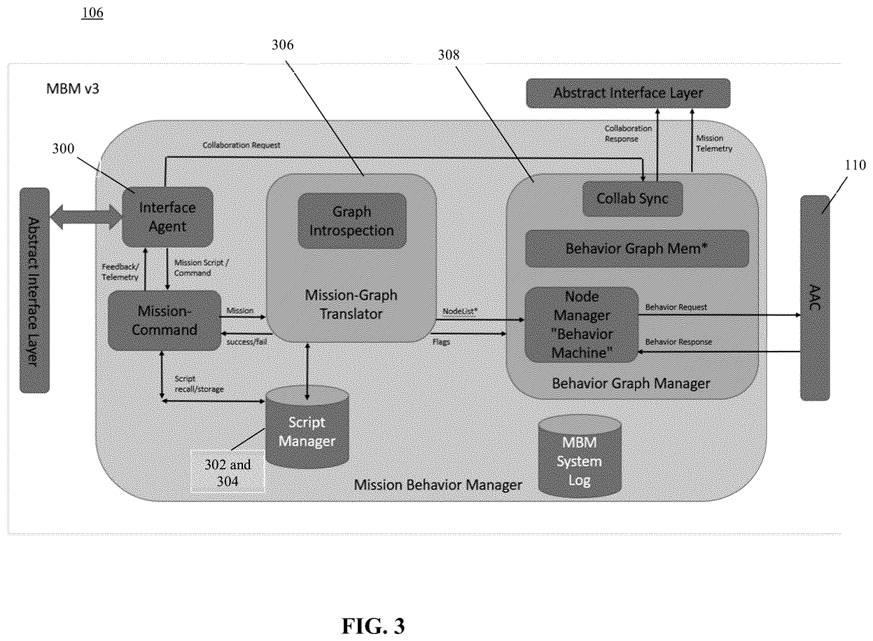

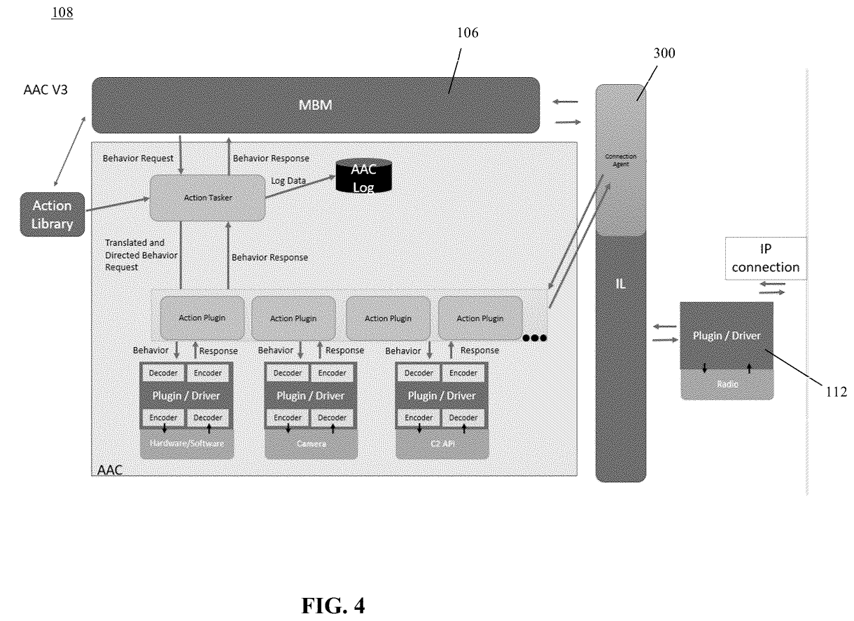

Referring to FIGS. 3-5, embodiments of the autonomous action deployment system 100 can include an interface agent 300. The interface agent 300 can be a module configured to send or receive a message and utilize encryption, serialization, and authentication to facilitate secure communication for the system 100. The interface agent 300 provides means to translate specific messages from a unique platform into a standardized language capable of being unpacked on any platform 110. The message sent or received by the interface agent 300 can include a mission script. The interface agent 300 can also be configured to provide information on the origin and destination authority of packets. Packet contents include but are not limited to mission scripts, data requests, telemetry, etc.

The MBM module 106 can include a script manager module 302 configured to determine whether the mission script received is a new mission script by comparing it to mission scripts stored in a mission script library 304. If it is determined that the mission script received is a new mission script, the script manager module 302 can add (e.g., store) the mission script to the mission script library 304. If the mission script received is not new, the script manager module 302 will update the local copy if it has a later timestamp than the stored version; otherwise, no action is necessary by the script manager module 302.

The MBM module 106 can include a mission graph translator (MGT) module 306 configured to parse the text file by giving a meaning to characters of the text file. The MGT module 306 can be configured to create the connected graph data structure by identifying and linking basic data structure units of the text file. The MGT module 306 can be further configured to create plural data structure nodes and link two or more data structure nodes.

The MGT module 306 can be configured to create plural data structure nodes for the mission script. Each data structure node can define an action for an autonomous vehicle platform 110. The MGT module 306 can arrange the plural data structure nodes in a connected graph manner such that a data structure node is required to be successfully accomplished or failed to be accomplished before moving on to another data structure node. This can facilitate execution of actions in a serial or parallel manner. In addition, the MGT module 306 can be configured to generate an error message when a node does not correspond with a plug-in stored in a plug-in library 114. This error message can be a signal sent to the one or more processors 102 that causes the one or more processors 102 to generate an audio and/or visual indication of the error. For instance, the one or more processors 102 can include a display 116 (e.g., a LCD monitor) that generates an audio and/or visual indication.

The MBM module 106 can include a behavior graph manager (BGM) module 308 configured to start the mission script. The BGM module 308 can further monitor results for each data structure node. As nodes are processing in the AAC module 108, feedback and result status are updated at a frequency determined by the developed plug-in. The feedback and status data points are utilized by the MBM module 106 to emit telemetry and mission status. Based on the results, the BGM module 308 can generate a corresponding plug-in command.

In some embodiments, autonomous action deployment system 100 includes the plug-in library 114—e.g., plug-in library 114 can be part of the system 100 or the autonomous action deployment system 100 includes the above-mentioned components in combination with plug-in library 114. In other embodiments, the plug-in library 114 can be a separate component (e.g., not controlled or operated by the system 100) from the system 100 but in communication with the system 100. In either case, the AAC module 108 is configured to execute plug-ins from the plug-in library 114. The AAC module 108 can be configured to utilize a set of pre-developed plug-ins for a particular autonomous vehicle platform 110 based on the mission script. For instance, the AAC module 108 can select an action plug-in from the plug-in library 114 for an autonomous vehicle platform 110 based on the action request commend generated by the MBM module 106. The AAC module 108 can then initialize the action plug-in for the autonomous vehicle platform 110 with a parameter and a goal set by the mission script. The initialization can occur via a dynamic library loader, for example. It should be noted that the pre-developed plugins can be action plug-ins used on any number of autonomous vehicle platforms 110, provided the capabilities of each are similar. Thus, the AAC module 108 can select one or more action plug-ins from the plug-in library 114 for one or more autonomous vehicle platforms 110 based on the action request commend(s) generated by the MBM module 106. The AAC module 108 can then initialize the one or more action plug-ins for the one or more autonomous vehicle platforms 110 with a parameter and a goal set by the mission script.

The autonomous vehicle platform 110 is for an autonomous vehicle. Thus, any one of the autonomous vehicle platforms 110 can include a hardware payload and a software payload for an autonomous vehicle.

The autonomous action deployment system 100 includes a single autonomous vehicle platform 100. The autonomous action deployment system 100 can communicate and otherwise interact with other autonomous action deployment systems 100 which are associated with their own autonomous vehicle platform 100.

Embodiments can relate to a method of deploying an autonomous action. The method can involve receiving a mission script that includes a text file. The method can involve parsing the text file into actions. The method can involve creating a data structure where each action exists as a node in a connected graph. The method can involve validating that each node corresponds with a plug-in stored in a plug-in library specific to an autonomous vehicle platform. The method can involve generating an action request command. The method can involve executing steps to accomplish the action request command for the autonomous vehicle platform via a corresponding driver.

The method can involve receiving plural mission scripts. The method can involve executing one or more action plug-ins for each node of each mission script.

Creating the connected graph data structure can involve identifying and linking basic data structure units of the text file. The method can involve creating plural data structure nodes for the mission script, each data structure node defining an action for an autonomous vehicle platform. The method can involve arranging the plural data structure nodes in a connected graph manner such that a data structure node is required to be successfully accomplished or failed to be accomplished before moving on to another data structure node.

As can be appreciated from the present disclosure, the CPAS framework is a full-stack autonomy solution that is deployable on any generalized unmanned system. It is vendor agnostic and easily integrated with other third party robotic systems. Today's autonomy ecosystem lacks the scalability and reusability necessary to allow for effective robot proliferation in support of mission objectives, with vendor lock-in creating duplicative development efforts and/or rigid systems. Currently, there is no framework that enables the connection of mission events with autonomous actions across multiple domains and hardware types.

The system 100 and mission agnostic autonomy framework enables users to design and deploy a generalized list of actions to accomplish high level missions. The framework also provides a standard language to support communication between the network of platforms and users. The framework is integratable onto any robotic asset and support non-OEM hardware and software payloads.

It is contemplated for the framework to be an open architecture and software product that enables rapid development, deployment, and reconfiguration of truly platform-agnostic autonomy. It can be ran on any operating system, but an exemplary operating system is Ubuntu OS. CPAS increases agility of unmanned technology deployment and usage, increases mission support capability and force effectiveness & safety, and answers the government's call for interoperability and technological unification. CPAS is comprised of two main components that work in tandem, the Mission Behavior Manager (MBM) and the Autonomous Action Controller (AAC). The AAC has both hardware and software interfaces to vendor specific peripherals, sensors, and payloads. The MBM is able to interact with other unmanned platforms in its surroundings for the purpose of information sharing and goal collaboration—i.e., MBM translates the mission scripts into actionable pieces of information and passes those commands to the autonomous action controller.

The current problem in robotics and autonomy is that autonomy is very platform specific, if it exists at all. CPAS is a software solution that allows for platform agnostic mission autonomy amongst various unmanned platforms to facilitate multi-agent collaboration and intuitive command and control. Unlike other solutions in the robotic autonomy space, CPAS increases human-machine teaming, is highly scalable and modular, and is network/communication protocol agnostic.

The software framework sits on top of the platform, the platform's command and control, low-level autonomy algorithms, and any non-OEM payloads. Due to its modular design, the framework simplifies the integration of autonomy and intuitive control onto robotic asset(s). The human centric design provides no-code drag and drop mission script builder and easy integration into familiar end-user devices.

The following is a description of an exemplary software flow and general process of sending a mission script to the MBM and then the running of the mission.

Exemplary process steps for mission script generation, reception, and processing can involve the following:
1. Developer generates a mission script offline
2. Developer defines high level configuration file that defines squad specific values
3. Developer Send a mission script to a powered unit to run
4. Mission script is received by the interface agent and sent to the MBM
5. The MBM decodes the message from the interface agent as an incoming mission script
6. The packet contents are sent to the Script Manager
   a. Script manager checks library to see if this is a previously known mission script
   b. Script manager adds new mission to mission library
   c. Script manager passes the mission contents to the Mission-Graph-Translator to be parsed
7. Mission Graph Translator (MGT) receives a mission from Script Manager and marks it as staged mission
   a. MGT parses JSON file
   b. MGT creates nodes from the AAC plugin library
   c. MGT validates that there is a plugin for each node type found in the mission script
      i. Sends an error to user if missing a plugin
   d. MGT grabs pointer to the start of the mission script node list to send to the Behavior Graph Manager
8. Behavior graph manager (BGM) starts the mission script and monitors the results of each node
   a. BGM sends mission telemetry to other members of the CPAS squad
9. Nodes are processed in the order that was defined in the mission script until there are no more nodes.

Exemplary process steps for operations within the ACC can involve the following:
1. AAC receives a vetted action request from the MBM
2. AAC uses a plugin factory to generate the corresponding platform-specific action plugin
3. AAC initializes the action plugin with the necessary parameters and goals
4. AAC starts running the action plugin as a separate process
5. Action plugin reports results to AAC and outcomes get forwarded to the MBM

Exemplary pseudo-code for the CPAS framework can include the following:

```
run_cpas_device(user_devices, platform_devices) {
  interface_layer <− interface_layer(default_to_tcp, user_devices, platform_devices)
  cpas_gui_interface <− cpas_gui_interface( )
}
run_cpas_platform(mission_string, action_library, user_devices, platform_devices) {
  platform_library <− action_library
  interface_layer <− interface_layer(default_to_tcp, user_devices, platform_devices)
  autonomous_action_controller <−
  autonomous_action_controller(platform_library)
  mission_behavior_manager <− mission_behavior_manager(mission_string,
  platform_library)
}
mission_behavior_manager(mission_string, platform_library) {
  friend autonomous_action_controller
  friend interface_layer
  active_behaviors = { }
  cache_mission(mission_string)
  behaviors, success_edges, fail_edges = mission_graph(mission_string)
  wait_for_callback( ) {
    time.sleep(N)
  }
  set_outcome_callback(behavior_uuid, outcome) {
  # Updates active action list based on outcome of behavior with action requests to
the AAC
    current_behavior = active_behaviors[behavior_uuid]
    if outcome == True:
      next_behaviors = success_edges[current_behavior]
    else:
      next_behaviors = fail_edges[current_behavior]
    for behavior in next_behaviors:
      active_behaviors[behavior.uuid] = behavior
      autonomous_action_controller.request_action(behavior)
      active_behaviors.remove(behavior_uuid)
  }
  if all(behaviors) not in platform_library:
    interface_layer.report(ground_station, “Platform specifications cannot
  complete required behaviors”)
  mission_ok = true
  # Start Condition := Start action
  # No failed edges for start action
  next_behaviors = success_edges[behaviors[0]]
  for behavior in next_behaviors:
    active_behaviors[behavior.uuid] = behavior
    autonomous_action_controller.request_action(behavior)
  # Exit Condition := Done action
  while(mission_ok && !active_behaviors.empty( )) {
    wait_for_callback( )
  }
}
autonomous_action_controller(platform_library) {
  friend mission_behavior_manager
  friend interface_layer
  active_actions = { }
  request_action(requested_action) {
    action_plugin =
    autonomous_action_controller.plugin_factory(requested_action.name,
  platform_library)
    action_plugin.set_parameters(requested_action.parameters)
    active_actions[requested_action.uuid] = action_plugin
    action_plugin.run_detached( )
  }
  action_outcome(action_uuid, outcome) {
    action_plugin = active_actions[action_uuid]
    action_plugin.clean( ) # Clean system
    action_plugin.join( ) # End action instance
    active_actions.remove(action_uuid)
    mission_behavior_manager.set_outcome(action_uuid, outcome)
  }
}
interface_layer(protocol=default_to_tcp, user_devices, platform_devices) {
  friend mission_behavior_manager
  friend autonomous_action_controller
  active_connections = { }
  devices = user_devices + platform_devices
  for device in devices:
    encrypted_authorization_response = request_connection(device)
    decrypted_authorization_response =
  decrypt(encrypted_authorization_response)
    connection_response =
  send_authorization(decrypted_authorization_response)
    if connection_response = True:
      active_connections[device.uuid] = connection(device, protocol)
  receive_callback(es_data) {
    s_data = decrypt(es_data)
    raw_data = deserialize(s_data)
    if raw_data.for_mbm:
      mission_behavior_manager.update_message_queue(raw_data)
    else:
      autonomous_action_controller.update_message_queue(raw_data)
  }
  send(device_uuid, raw_data) {
    if device_uuid in active_connections:
      s_data = serialize(raw_data)
      es_data = encrypt(s_data)
      active_connections[device_uuid].send(es_data)
  }
}
```

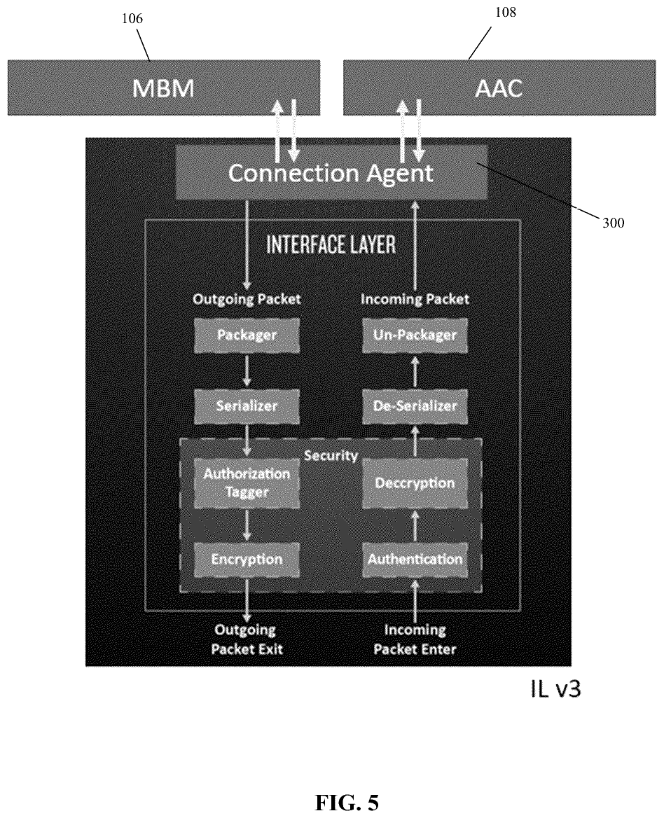

Referring to FIG. 5, exemplary process steps and operating modules for operations in the interface agent can involve:
Connection Agent: Physical platform (i.e. drone) that each instance of CPAS runs on. Incoming and Outgoing messages pass through the Interface for appropriate packaging and security measures.
Packager/ Un-packager: In this step, protobufs are used to efficiently package (outgoing) or unpackage (incoming) messages.
Serializer/De-serializer: Protobuf messages outgoing are placed in a special transport protobuf and serialized. Incoming messages are deserialized and a class of protobuf instructions are used to transform the transport protobuf into a specific protobuf message.
Authorization Tagger: For outgoing messages, specific flags are attached to the message that limit Access to only the portions of the CPAS environment that needed for the action. For example, if the message is meant to be used in the MBM, it will only have Access to the MBM functionality of CPAS.
Encryption/Decryption: Messages will undergo AES or other appropriate cryptography to provide a layer of security
Authentication: Before a received message is allowed access in an instance of CPAS, it must successfully pass a handshake authentication protocol.

One of the novel aspects of the CPAS framework lies in the implementation of the MBM, AAC, and Mission Scripts. Regarding the MBM and mission script interchange, the MBM runs a customized implementation of a hybrid Finite State Machine (FSM) and Behavior Tree (BT) to perform tasks that together define a mission. Below is a table of differences between traditional FSMs & BTs and the CPAS control structure.

| | FSM | BT | CPAS Missions |
|---|---|---|---|
| Construction | State based diagrams | Directed Graph | Directed Graph |
| | | Representation | Representation |
| Computations | Transition costs are | Location in Graph is | Movements on the |
| | minimal | computed each time | graph do not require |
| | | iteration | computations, previous |
| | | | nodes launch the next |
| | | | node based on outcome |
| Feedback | State feedback is done | The Active node | Provides for |
| | via reading the FSM | reports success, failure, | customized feedback |
| | state from another | running, or error at | determined by the |
| | process | each time iteration | node's payload |
| Transitions | Transitions are | Execution is from left | Each node has a |
| | dictated by changes in | to right, top to bottom | success/fail path that |
| | state | from the root node | can trigger multiple |
| | | | other nodes to run |
| Maintainability | Requires | BTs can be nested in | Missions can be nested |
| | Hierarchical-FSM to | other BTs to form | in other missions by |
| | nest nodes. High | complex behaviors | connecting the |
| | degree of effort to | | input/outputs |
| | maintain or | | |
| | add/remove new | | |
| | states | | |
| Logic | Determined by state | Logic in BTs are | Logic can be implicit |
| | transition values | acomplished through | via connection of nodes |
| | | conditions nodes | or explicit through |
| | | | construction of logic |
| | | | nodes |

One of the technical improvements of the system 100 is the interaction of the MBM and the AAC. Each node in a mission script defines an action that the platform needs to accomplish or fail before moving on to the next action. A particular platform must be loaded with the plugin libraries for each action that is contained within the mission script. The MBM reads from the available plugins in the libraries and uses that to scrub the current mission for action if it can complete a mission or not. This can be referred to as Mission Graph Introspection (see FIG. 3), and it allows for the ability to deploy the same exact mission script to multiple platforms, wherein each platform will respond appropriately to the tasks in the mission. This enables developers and users of CPAS high reusability of mission scripts to cut down on development time.

Some embodiments of the mission scripts and the AAC themselves may not poses novel concepts. For instance, a mission script may be a series of user defined connected graphs using a CPAS defined schema for input, output, and data transition ports. The AAC can manage a set of CPAS plugins that contain hardware or software payloads so that they can be called from the currently running mission. An item to note is that once a plugin is developed for a particular hardware or software payload, it can be used on any CPAS system with minor modifications, if they are needed.

It will be understood that modifications to the embodiments disclosed herein can be made to meet a particular set of design criteria. For instance, any of the components of the system 100 can be any suitable number or type of each to meet a particular objective. Therefore, while certain exemplary embodiments of the system 100 and methods of using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. An autonomous action deployment system, comprising:
one or more processors including a mission behavior manager (MBM) module and an autonomous action controller (AAC) module, the one or more processors configured to interface with one or more autonomous vehicle platforms; and
wherein the MBM module is configured to receive a mission script that includes a text file, parse the text file into actions, create a data structure where each action exists as a node in a connected graph, validate that each node corresponds with a plug-in stored in a plug-in library specific to an autonomous vehicle platform, and generate an action request command; and
wherein the AAC module is configured to receive the action request command and execute steps to accomplish the action request command for the autonomous vehicle platform via a corresponding driver.

2. The autonomous action deployment system of claim 1, wherein:
the mission script is an action or behavior command aggregate for one or more autonomous vehicle platforms.

3. The autonomous action deployment system of claim 1, wherein:
the MBM module is configured to receive plural mission scripts; and
the AAC module is configured to execute one or more action plug-ins for each node of each mission script.

4. The autonomous action deployment system of claim 1, comprising:
an interface agent configured to send or receive a message and utilize encryption, serialization, authentication, and/or authorization to facilitate secure communication.

5. The autonomous action deployment system of claim 1, wherein:
the MBM module includes a script manager module configured to determine whether the mission script is a new mission script by comparing it to mission scripts stored in a mission script library, and add the mission script to the mission script library when the mission script is a new mission script.

6. The autonomous action deployment system of claim 1, wherein:
the MBM module includes a mission graph translator (MGT) module configured to parse the text file by giving a meaning to characters of the text file.

7. The autonomous action deployment system of claim 1, wherein:
the MBM module includes a mission graph translator (MGT) module configured to create the connected graph data structure by identifying and linking basic data structure units of the text file.

8. The autonomous action deployment system of claim 7, wherein:
the MGT module is configured to create plural data structure nodes and link two or more data structure nodes.

9. The autonomous action deployment system of claim 7, wherein:
the MGT module is configured to create plural data structure nodes for the mission script, each data structure node defining an action for an autonomous vehicle platform; and
the MGT module arranges the plural data structure nodes in a connected graph manner such that a data structure node is required to be successfully acomplished or failed to be acomplished before moving on to another data structure node.

10. The autonomous action deployment system of claim 9, wherein:
the MBM module includes a behavior graph manager (BGM) module configured to start the mission script, monitor results for each data structure node, and generate a corresponding plug-in command.

11. The autonomous action deployment system of claim 1, wherein:
the MGT module is configured to generate an error message when the node does not correspond with a plug-in stored in a plug-in library.

12. The autonomous action deployment system of claim 1 in combination with a plug-in library.

13. The autonomous action deployment system of claim 12, wherein:
the AAC module is configured to execute plug-ins from the plug-in library.

14. The autonomous action deployment system of claim 1, wherein:
the AAC module is configured to utilize a set of pre-developed plug-ins for a particular autonomous vehicle platform based on the mission script.

15. The autonomous action deployment system of claim 1, wherein:
the AAC module is configured to initialize the action plug-in for an autonomous vehicle platform with a parameter and a goal set by the mission script.

16. The autonomous action deployment system of claim 1, wherein:
the autonomous vehicle platform includes a hardware payload and a software payload for an autonomous vehicle.

17. The autonomous action deployment system of claim 1 in combination with an autonomous vehicle platforms.

18. A method of deploying an autonomous action, the method comprising:
receiving a mission script that includes a text file;
parsing the text file into actions;
creating a data structure where each action exists as a node in a connected graph;
validating that each node corresponds with a plug-in stored in a plug-in library specific to an autonomous vehicle platform;
generating an action request command; and
executing steps to accomplish the action request command for the autonomous vehicle platform via a corresponding driver.

19. The method of claim 18, comprising:
receiving plural mission scripts; and
executing one or more action plug-ins for each node of each mission script.

20. The method of claim 18, wherein creating the connected graph data structure involves
identifying and linking basic data structure units of the text file, the method comprising:
creating plural data structure nodes for the mission script, each data structure node defining an action for an autonomous vehicle platform; and
arranging the plural data structure nodes in a connected graph manner such that a data structure node is required to be successfully accomplished or failed to be accomplished before moving on to another data structure node.
